(19) United States
(12) Patent Application Publication
(10) Pub. No.: US 2007/0136544 A1
(43) Pub. Date: Jun. 14, 2007

(54) Information processing apparatus and memory control method

(76) Inventor: Hiroyuki Oda, Akishima-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/605,800

(22) Filed: Nov. 29, 2006

(30) Foreign Application Priority Data
Nov. 30, 2005 (JP) 2005-347042

(51) Int. Cl. G06F 13/00

(52) U.S. Cl. 711/167

(57) ABSTRACT

According to one embodiment, an information processing apparatus includes a memory, a storage unit which stores specifications of the memory, a unit which acquires a second timing parameter which causes speed of accessing the memory to be lowered compared to a first timing parameter, the first timing parameter being based on a first frequency and the specifications of the memory stored in the storage unit, and a controller which controls access to the memory based on the second timing parameter.

### CROSS-REFERENCE TO RELATED APPLICATIONS

This application is based upon and claims the benefit of priority from Japanese Patent Application No. 2005-347042, filed Nov. 30, 2005, the entire contents of which are incorporated herein by reference.

### BACKGROUND

1. Field

One embodiment of the invention relates to an information processing apparatus in which the speed of accessing a memory is controlled to reduce the consumption of power, and a memory control method for realizing the control.

2. Description of the Related Art

In recent years, various portable personal computers of a notebook type or laptop type have been developed. These computers are powered by a battery. To increase the powering duration of batteries, various contrivances have been made so far.

For instance, a technique for suppressing the power consumption of a memory is disclosed (see, for example, Jpn. Pat. Appln. KOKAI Publications Nos. 8-106339, 10-188567 and 10-209284).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic perspective view illustrating an exemplary personal computer according to an embodiment of the invention;

FIG. 2 is an exemplary block diagram illustrating the circuit configuration of the personal computer of the embodiment;

FIG. 3 is an exemplary view illustrating a window for setting a low-speed mode, employed in the embodiment;

FIG. 4 is an exemplary flowchart useful in explaining the procedure of setting timing parameters related to the speed of accessing a memory, employed in the embodiment; and

FIG. 5 is an exemplary view illustrating an example of information acquired by the system BIOS from SPD.

### DETAILED DESCRIPTION

Various embodiments according to the invention will be described hereinafter with reference to the accompanying drawings. In general, according to one embodiment of the invention, an information processing apparatus includes a memory, a storage unit which stores specifications of the memory, a unit which acquires a second timing parameter which causes speed of accessing the memory to be lowered compared to a first timing parameter, the first timing parameter being based on a first frequency and the specifications of the memory stored in the storage unit, and a controller which controls access to the memory based on the second timing parameter.

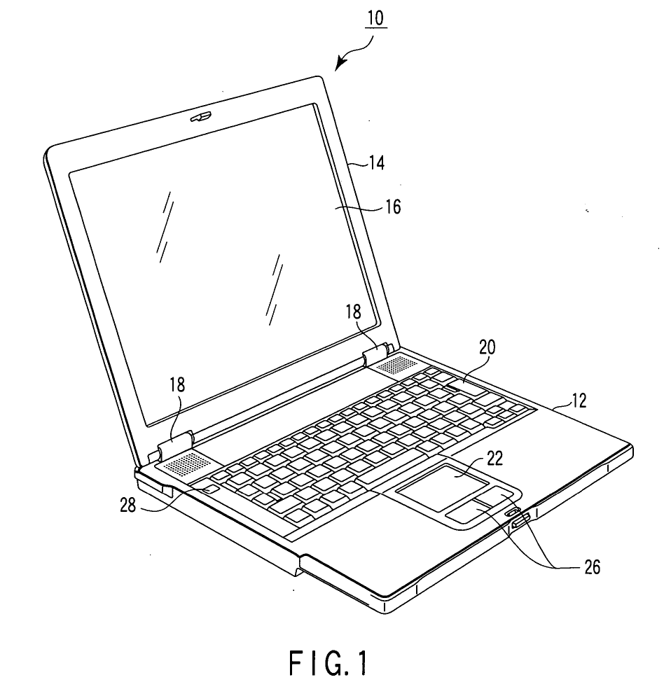

FIG. 1 shows an example of a notebook personal computer as an information processing apparatus according to an embodiment of the invention.

As shown, the personal computer 10 comprises a body 12 and display unit 14. The display unit 14 incorporates a liquid crystal display (LCD) 16 as a display section.

The display unit 14 is attached to the body 12 by hinges (support members) 18 so that it can pivot between an open position in which the upper surface of the body 12 is exposed, and a closed position in which the unit 14 covers the upper surface of the body 12.

The body 12 has a case of a thin box shape, and a keyboard 20 is provided on the central portion of the upper surface of the case. A palm rest is formed at the upper surface of the front portion of the body 12. A touch pad 22 as operation means, and touch-pad control buttons 26 are provided at substantially the central portion of the palm rest. A power button 28 for turning on/off the body 12 is provided on the upper surface of the rear side portion of the body 12.

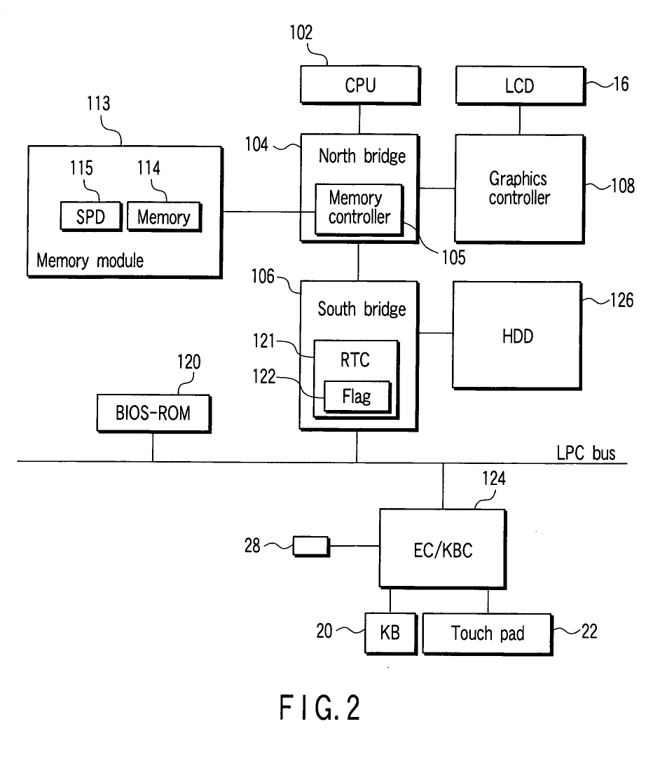

Referring now to FIG. 2, the system configuration of the computer will be described.

As shown in FIG. 2, the computer includes a CPU 102, north bridge 104, memory module 113, graphics controller 108, south bridge 106, BIOS-ROM 120, hard disk drive (HDD) 126, embedded controller/keyboard controller IC (EC/KBC) 124 and power supply 125, etc.

The CPU 102 is a processor for controlling the entire operation of the computer, and executes an operating system (OS) and various application programs loaded from the hard disk drive (HDD) 126 to a main memory 114 mounted on the memory module 113.

Further, the CPU 102 loads a basic input output system (system BIOS) from the BIOS-ROM 120 to the main memory 114, and executes it. The system BIOS is a program for hardware control. The system BIOS is used to acquire the core clock and timing parameters for the memory and set the memory controller 105 in accordance with the specification information of the memory 114 stored in a Serial Presence Detect (SPD) 115 mounted on the memory module 113.

The north bridge 104 is a bridge device for connecting the local bus of the CPU 102 to the south bridge 106. The north bridge 104 contains a memory controller 105 for controlling access to the main memory 114. Further, the north bridge 104 has a function for communicating with the graphics controller 108 via, for example, an Accelerated Graphics Port (AGP) bus.

The graphics controller 108 is a display controller for controlling an LCD 16 used as the display monitor of the computer. The graphics controller 108 includes a video memory (VRAM), and generates a video signal corresponding to an image to be displayed on the LCD 16, from display data stored in the video memory by an OS/application program. The video signal generated by the graphics controller 108 is output to a line.

The south bridge 106 is connected to a Peripheral Component Interconnect (PCI) bus and Low Pin Count (LPC) bus. Further, the south bridge 106 contains a real-time clock (RTC) 121. The real-time clock (RTC) 121 is a clock module for counting dates and time, and is operated by a battery dedicated thereto even when the computer 10 is powered off. Further, the real-time clock (RTC) 121 includes a low-speed-mode flag 122. When the low-speed-mode flag 122 is enabled, the speed of accessing the memory 114 is slower than a standard one, thereby suppressing the power consumption of the entire computer 10.

The embedded controller/keyboard controller IC (EC/KBC) 124 controls the touch pad 22 as input means, and the touch-pad control button 26. The embedded controller/keyboard controller IC (EC/KBC) 124 is a one-chip microcomputer for monitoring and controlling various devices (peripheral devices, sensors, power supply circuit, etc.) regardless of the state of the computer 10.

A description will now be given of a main-memory power-saving mechanism mounted in the computer 10. The computer 10 has two modes, i.e., a high-speed mode in which the speed of accessing the memory 114 is highest, and a low-speed mode in which the speed of accessing is lowest. When the low-speed-mode flag is enabled, the memory is accessed in the low-speed mode. In the low-speed mode in which the access speed is lowest, not only the core clock for the memory 114, but also timing parameters (tCL, tRAS, tRP, tWR) related to access speed are set to their respective lowest values supported by the memory 114 and memory controller 105, thereby reducing the power consumption of the memory 114.

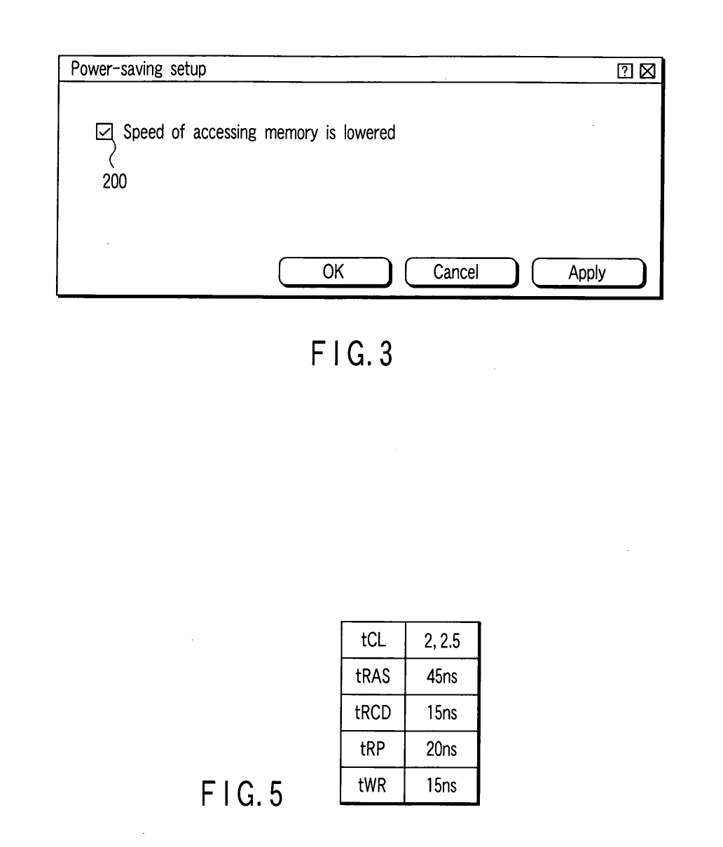

Referring to FIG. 3, a description will be given of a window displayed by an application for setting the low-speed-mode flag 122. The application for setting the low-speed-mode flag 122 operates on the operating system. As shown in FIG. 3, when a check box 200 is checked, the low-speed-mode flag 122 is enabled, while when the check mark is removed from the check box 200, the low-speed-mode flag 122 is disabled.

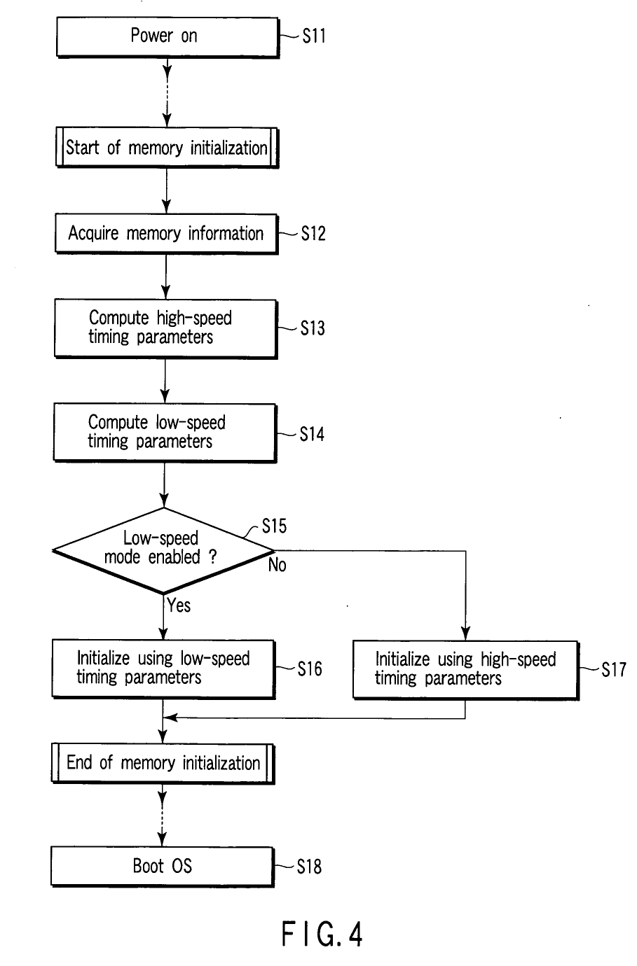

Referring then to FIG. 4, the procedure of setting the timing parameters related to access speed for the memory will be described.

Upon power on, the CPU 111 executes the system BIOS stored in a flash BIOS-ROM 118 (block S11). The system BIOS starts the initialization of the memory.

Subsequently, the system BIOS acquires, from the SPD 115, information, such as tCL (CAS latency), tRAS (Raw active time), tRCD (RAD to CAS delay time) and tRP (Row precharge time) (block S12). For instance, FIG. 5 shows information acquired by the system BIOS from the SPD 115. In FIG. 5, tCL is expressed by the number of clocks, and tRAS, tRCD, tRP and tWR are expressed by time units.

The system BIOS extracts, from the acquired information, timing parameters for the high-speed mode (block S13), and sets tCL to 2. If the memory is of the DRR226 standards, it generally operates at 133 MHz, therefore one clock is 7.5 ns.

Further, since tRAS acquired from the SPD 115 is 45 ns, RAS is 6 clocks (=45 ns/7.5 ns). Similarly, since tRCD acquired from the SPD 115 is 15 ns, RCD is 2 clocks (=15 ns/7.5 ns). Since tRP acquired from the SPD 115 is 20 ns, RP is 3 clocks (=20 ns/7.5 ns=2.66 . . . ). Further, since tWR acquired from the SPD 115 is 15 ns, WR is 2 clocks (=15 ns/7.5 ns)

After that, the system BIOS acquires timing parameters for the low-speed mode (block S14). The acquired timing parameters are set to the lowest values supported by the memory 114 and memory controller 105. For instance, CL, RAS, RCD, RP and WR are 2.5 clocks, 7 clocks, 3 clocks, 4 clocks, and 4 clocks, respectively.

The system BIOS determines whether the low-speed-mode flag is enabled (block S15). If the low-speed-mode flag is enabled (Yes at block S15), the system BIOS sets the core clock for the memory to 100 MHz, and initializes the memory controller 105 using the low-speed-mode parameters acquired at block S14, which is the termination of memory initialization (block S16). If the low-speed-mode flag is disabled (No at block S15), the system BIOS sets the core clock for the memory to 133 MHz, and initializes the memory controller 105 using the parameters acquired at block S13, which is the termination of memory initialization (block S17).

After memory initialization, the system BIOS performs several processes, and then boots the operating system (OS) (block S18).

As described above, in the low-speed mode, the timing parameters related to access speed are set so that the speed of accessing the main memory 114 is lowered compared to the high-speed mode, with the result that the intervals of access to the memory 114 are widened to reduce the power consumption of the memory 114.

In the embodiment, in the low-speed mode, the timing parameters are set to the values that cause the speed of accessing the memory to be set lowest. However, the invention is not limited to this. It is sufficient if the speed of accessing the memory is lower in the low-speed mode than in the high-speed mode.

Further, in the high-speed mode, the speed of accessing the memory may not always be set to the highest value.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a memory;
a storage unit which stores specifications of the memory;
a unit which acquires a second timing parameter which causes speed of accessing the memory to be lowered compared to a first timing parameter, the first timing parameter being based on a first frequency and the specifications of the memory stored in the storage unit; and
a controller which controls access to the memory based on the second timing parameter.

2. The information processing apparatus according to claim 1, wherein the controller sets a core clock for the memory to a second frequency lower than the first frequency.

3. The information processing apparatus according to claim 1, wherein the second timing parameter is set to a lowest one of values supported by the memory and the controller.

4. The information processing apparatus according to claim 1, wherein the specifications of the memory stored in the storage unit include tCL (CAS latency), tRAS (Raw active time), tRCD (RAD to CAS delay time), tRP (Row precharge time) and tWR (write recovery time).

5. The information processing apparatus according to claim 1, further comprising:
a setting unit which sets whether access control of the memory is to be performed based on the second timing parameter; and
a acquiring unit which acquires the first timing parameter,
and wherein when the setting unit sets that the access control of the memory based on the second timing parameter is not performed, the controller performs access control of the memory based on the first timing parameter.

6. The information processing apparatus according to claim 5, wherein when the setting unit sets that the access control of the memory based on the second timing parameter is not performed, the controller sets the core clock for the memory to the first frequency.

7. The information processing apparatus according to claim 5, wherein the unit which acquires the first timing parameter acquires the first timing parameter to cause the speed of accessing the memory to become highest without departing from the specifications of the memory.

8. A memory control method for use in an information apparatus including a memory, a storage unit which stores specifications of the memory, and a controller which controls access to the memory, comprising:
acquiring a second timing parameter which causes speed of accessing the memory to be lowered compared to a first timing parameter, the first timing parameter being based on a first frequency and the specifications of the memory stored in the storage unit; and
setting the second timing parameter as a parameter for controlling access to the memory in the controller.

9. The memory control method according to claim 8, further comprising setting a core clock for the memory to a second frequency lower than the first frequency.

10. The memory control method according to claim 8, wherein the second timing parameter is set to a lowest one of values supported by the memory and the controller.

11. The memory control method according to claim 8, wherein the specifications of the memory stored in the storage unit include tCL (CAS latency), tRAS (Raw active time), tRCD (RAD to CAS delay time), tRP (Row precharge time) and tWR (write recovery time).

12. The memory control method according to claim 8, further comprising:
setting whether access control of the memory is to be performed based on the second timing parameter;
acquiring the first timing parameter;
determining whether it is set that the access control of the memory based on the second timing parameter is not performed; and
setting, in the controller, the first timing parameter as the parameter for controlling access to the memory, when it is set that the access control of the memory based on the second timing parameter is not performed.

13. The memory control method according to claim 12, further comprising setting the core clock for the memory to the first frequency, using the controller, when it is set that the access control of the memory based on the second timing parameter is not performed.

14. The memory control method according to claim 12, wherein the unit which acquires the first timing parameter acquires the first timing parameter to cause the speed of accessing the memory to become highest without departing from the specifications of the memory.
